(19) United States
(12) Patent Application Publication
(10) Pub. No.: US 2024/0002104 A1
(43) Pub. Date: Jan. 4, 2024

(54) A CONTAINER

(71) Applicant: THE MERVEILLE COMPANY, INC., Broomfield, CO (US)

(72) Inventor: Debra JONES, Nederland, CO (US)

(73) Assignee: THE MERVEILLE COMPANY, INC., Broomfield, CO (US)

(21) Appl. No.: 18/039,436

(22) PCT Filed: Dec. 6, 2021
(86) PCT No.: PCT/US2021/062040

§ 371 Date: May 30, 2023

Related U.S. Application Data
(60) Provisional application No. 63/122,212, filed on Dec. 7, 2020.

(51) Int. Cl. B65D 25/06; B65D 43/12; B65D 51/24

(52) U.S. Cl. CPC B65D 25/06; B65D 43/12; B65D 51/247; B65D 2543/00101; B65D 2543/00296

(57) ABSTRACT

A container (100) and a method of fabricating a container are described. The container comprises a junction member (200) and a first compartment (300). The junction member comprises a junction member planar portion (202) surrounded on a periphery by a junction member band portion (204). The junction member band portion (204) comprises one or more extensions (212) projecting inward from the junction member band portion (204) between the junction member planar portion (202) and the first end (206). The first compartment (300) comprises a first compartment storage portion (302) comprising silicone and a first compartment band (304) positioned around a mouth end (306) of the first compartment storage portion. The mouth end comprises a mouth lip (310) configured to be sealingly retained between the junction member planar portion (202) and the one or more extensions of the junction member (212). The first compartment storage portion (302) is configured to be folded via one or more predetermined pleats (312) so that at least 85% of a height (332) of the one or more predetermined pleats is within a volume of the junction member band portion when the first compartment (300) is coupled to the junction member.

### TECHNICAL FIELD

The present Application is directed towards containers, and more particularly, to folding containers.

### BACKGROUND

Businesses and consumers are trying find solutions to reduce waste from food packaging and find sustainable solutions. Plastic is often the material of choice in food packaging because it's lightweight, durable, and easy to manufacture. Every year, however, the world produces 400 million tons of plastic. More than 40% of the plastic trash generated is single-use, and it can stay in our environment for hundreds of years. Moreover, consumers are also increasingly becoming aware that chemicals can leech into food when plastic comes into contact with food.

Other consumers may not like the aesthetics of the typical rigid plastic food container. Plastic food containers can scratch and stain, especially when food is heated and eaten out of them directly. Rigid plastic containers can take up a lot of room when ported around in a backpack or a shoulder bag. Plastic containers can break when dropped. Finally, not all plastic is dishwasher or microwave safe.

Silicone is a safer option for food containers because it does not leech chemicals into food. Silicone that can be heated in a microwave and washed in a dishwasher safely. Due to the flexible nature of silicon, however, it can be tricky to build food containers out of it.

Prior food containers incorporating silicone often repurpose plastic container designs, removing the bottom plastic bowl portion and replacing it with silicone bowls that can be folded up when not in use. To facilitate orderly folds in the silicone, prior designs used a stepped profile in silicone material having a relatively uniform thickness of 0.4-0.7 mm. The stepped profile silicone bowls created eating containers that rapidly become narrower towards the bottom of the container, which in many cases is not an ideal container format for consumers to eat out of.

Prior silicone container bowls do not feel sturdy, especially when the containers can hold volumes of a liter or greater.

Some prior foldable silicone containers collapse too easily or are awkward to refold.

Finally, silicone is also a very expensive material to manufacture from. This may be one of the reasons that prior silicone container bowls incorporate so much plastic into their designs.

What is needed is a foldable silicone food container that incorporates less plastic, minimizes contact between plastic and food, feels solid, is compact when folded, flexible to use, is suitable for bigger volumes, less expensive, and is elegant in design.

### SUMMARY

A container is provided. The container comprises a junction member comprising a junction member planar portion surrounded on a periphery by a junction member band portion. The junction member band portion comprises a first end and a second end along a longitudinal axis of the junction member band portion. The junction member band portion further comprises one or more extensions projecting inward from the junction member band portion between the junction member planar portion and the first end. The container further comprises a first compartment comprising a first compartment storage portion comprising silicone with a mouth end and a bottom end. A first compartment band is positioned around the mouth end of the first compartment storage portion. The mouth end comprises a mouth lip configured to be sealingly retained between the junction member planar portion and the one or more extensions of the junction member. The first compartment storage portion is configured to be folded via one or more predetermined pleats so that at least 85% of a height of the one or more predetermined pleats fits within a volume of the junction member band portion when the first compartment is coupled to the junction member.

A method to fabricate a container is provided. The method comprises providing a junction member, providing a first component, and coupling the junction member and the first compartment together. The container comprises a junction member comprising a junction member planar portion surrounded on a periphery by a junction member band portion. The junction member band portion comprises a first end and a second end along a longitudinal axis of the junction member band portion. The junction member band portion further comprises one or more extensions projecting inward from the junction member band portion between the junction member planar portion and the first end. The container further comprises a first compartment comprising a first compartment storage portion comprising silicone with a mouth end and a bottom end. A first compartment band is positioned around the mouth end of the first compartment storage portion. The mouth end comprises a mouth lip configured to be sealingly retained between the junction member planar portion and the one or more extensions of the junction member. The first compartment storage portion is configured to be folded via one or more predetermined pleats so that at least 85% of a height of the one or more predetermined pleats fits within a volume of the junction member band portion when the first compartment is coupled to the junction member.

### Aspects

In a further aspect, the first container storage portion may further comprise an average thickness of silicon, with one or more sections of silicone that are thinner than the average thickness and configured to allow the first container storage portion to form the one or more predetermined pleats when pressure is applied to the bottom end opposing the mouth end of the first container portion in the direction of the mouth end.

In a further aspect, the first container storage portion may further comprise a base portion coupled to the bottom end, the base portion being formed from a material that is stiffer than silicone and coupled to the bottom end.

In a further aspect, the mouth lip of the first compartment storage portion may further comprise an annular ring portion that extends away from the center of the first compartment storage portion at the mouth end and a perpendicular portion that extends away from the annular ring portion towards the bottom end of the first compartment storage portion, and the first compartment band may further comprise a rail lip at a first end of the first compartment band configured to seat the perpendicular portion of the first compartment storage portion.

In a further aspect, the first compartment storage portion may further comprise a lower seat lip spaced apart from the rail lip, a distance between the rail lip and the lower seat lip being configured to snuggly secure the first compartment band portion to the first compartment storage portion between the rail lip and the lower seat lip.

In a further aspect, the junction member planar portion may further comprise a depression configured to hold one or more tools, wherein the depression does not interfere with folding the one or more predetermined pleats within the junction member band portion when the first compartment is coupled to and folded into the junction member.

In a further aspect, the container may further comprise one or more removable dividers configured to be placed in the first container storage portion, thereby subdividing the first container storage portion.

In a further aspect, the one or more removable dividers may be configured to fit within the one or more predetermined pleats of the first container storage portion when the first container is coupled to and folded into the junction member.

In a further aspect, the container may further comprise a second compartment comprising a second compartment planar portion and a second compartment storage portion coupled to a surface of the second compartment planar portion, wherein the second end of the junction member is configured to couple to the second compartment planar portion.

In a further aspect, the junction member may further comprise a junction member rail positioned at the second end of the junction member band portion, the junction member rail surrounding at least a portion of a circumference of the junction member band portion and configured to seat the second compartment planar portion when inserted into the junction member rail via a sliding motion in a direction parallel to the length of the second compartment planar portion.

In a further aspect, the second compartment storage portion may further comprise a second compartment container portion and a second compartment cover configured to seal the second compartment container portion.

In a further aspect, the second compartment cover may be configured to seat around a periphery of the second compartment planar portion and the junction member rail may be configured to seat a combined height of the junction member planar portion and the second compartment cover.

In a further aspect, the second compartment cover may be fabricated from silicone having a first weight and the second compartment container portion is fabricated from a silicone having a second weight that is higher than the first weight.

In a further aspect, the first compartment band and the junction member are fabricated from plastic.

In a further aspect, the method may further comprise providing a second compartment comprising a second compartment planar portion and a second compartment storage portion coupled to a surface of the second compartment planar portion, wherein the second end of the junction member is configured to couple to the second compartment planar portion. The method may further comprise coupling the second compartment to the junction member.

In a further aspect, providing the junction member may further comprise providing a junction member rail positioned at the second end of the junction member band portion, the junction member rail surrounding at least a portion of a circumference of the junction member band portion and configured to seat the second compartment planar portion when inserted into the junction member rail via a sliding motion, and coupling the second compartment to the junction member may further comprise sliding the second compartment in a direction parallel to the length of the second compartment planar portion.

In a further aspect, providing the second compartment may further comprise providing the second compartment storage portion with a second compartment container portion and a second compartment cover configured to seal the second compartment container portion.

In a further aspect, providing the second compartment may further comprise configuring the second compartment cover to seat around a periphery of the second compartment planar portion, and providing the junction member may further comprise configuring the junction member rail to seat a combined height of the junction member planar portion and the second compartment cover.

### BRIEF DESCRIPTION OF THE DRAWINGS

The same reference number represents the same element on all drawings. The drawings are not necessarily to scale.

FIG. 1A depicts a container 100, in accordance with an embodiment;

FIG. 1B depicts a container 100, in accordance with an embodiment;

FIG. 1C depicts a container 100, in accordance with an embodiment;

FIG. 1D depicts a container 100, in accordance with an embodiment;

FIG. 1E depicts a container 100, in accordance with an embodiment;

FIG. 1F depicts a container 100, in accordance with an embodiment;

FIG. 1G depicts a container 100, in accordance with an embodiment;

FIG. 2A depicts a junction member 200, in accordance with an embodiment;

FIG. 2B depicts a junction member 200, in accordance with an embodiment;

FIG. 2C depicts a junction member 200, in accordance with an embodiment;

FIG. 2D depicts a junction member 200, in accordance with an embodiment;

FIG. 2E depicts a junction member 200, in accordance with an embodiment;

FIG. 3A depicts a first container 300, in accordance with an embodiment;

FIG. 3B depicts a first container 300, in accordance with an embodiment;

FIG. 3C depicts a first container 300, in accordance with an embodiment;

FIG. 3D depicts a first container 300, in accordance with an embodiment;

FIG. 3E depicts a first container 300, in accordance with an embodiment;

FIG. 3F depicts a first container 300, in accordance with an embodiment;

FIG. 4A depicts a second container 400, in accordance with an embodiment;

FIG. 4B depicts a second container 400, in accordance with an embodiment;

FIG. 4C depicts a second container 400, in accordance with an embodiment;

FIG. 4D depicts a second container 400, in accordance with an embodiment;

FIG. 4E depicts a second container 400, in accordance with an embodiment; and

FIG. 5 depicts a method 500 in accordance with an embodiment.

### DETAILED DESCRIPTION

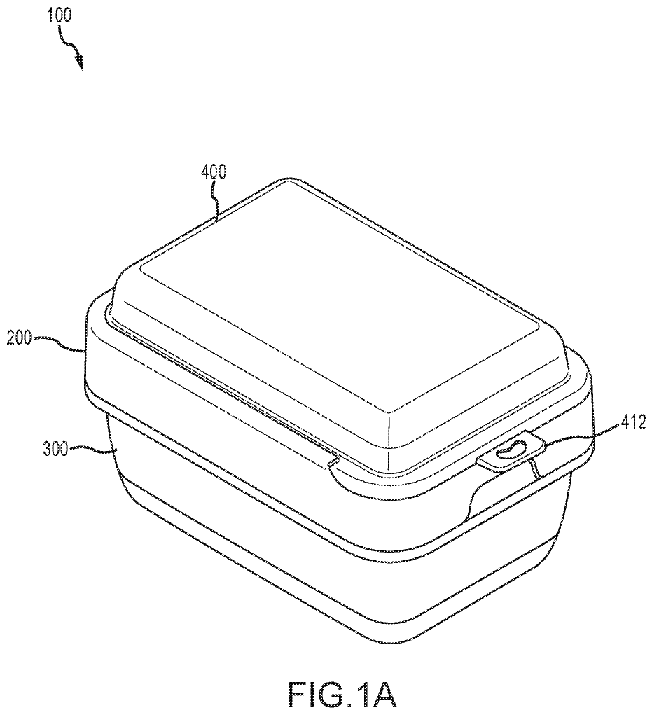

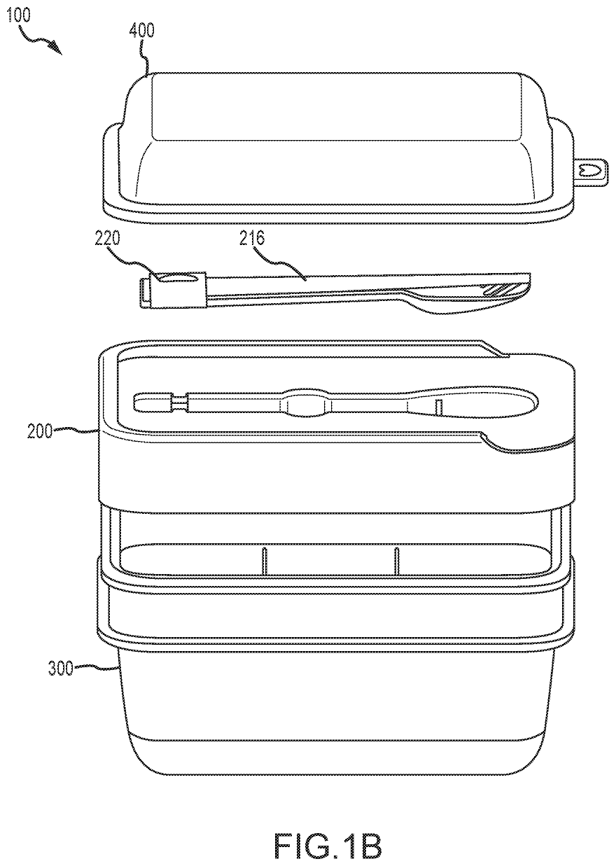

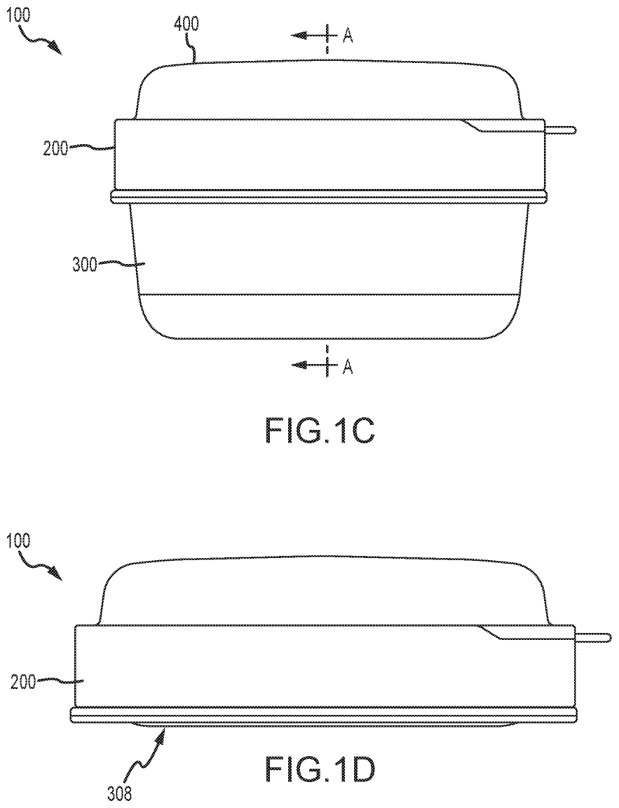

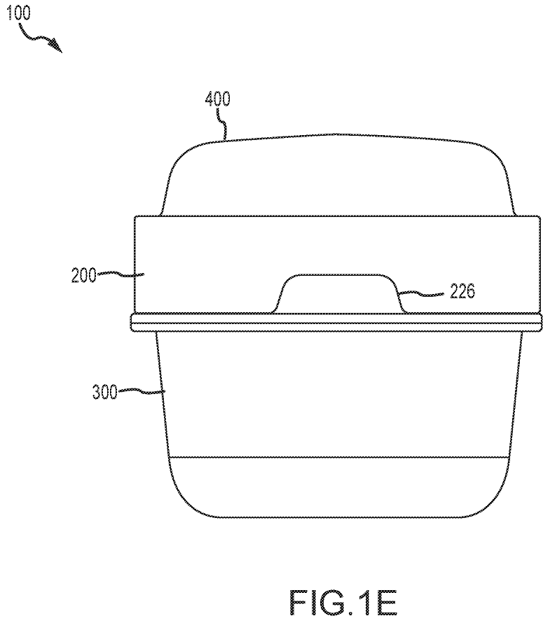

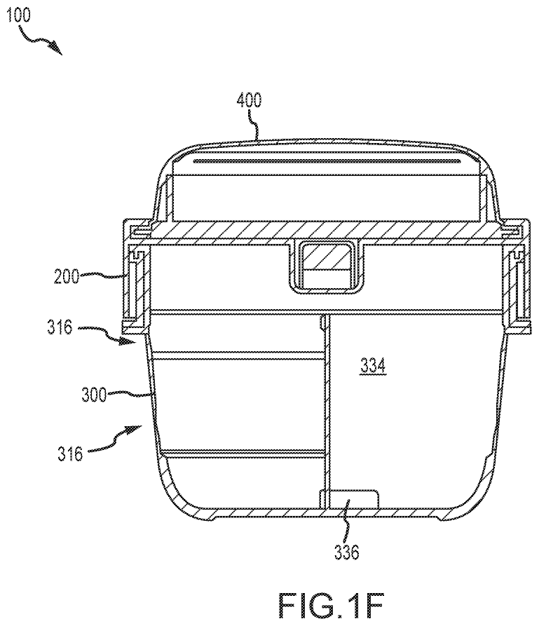

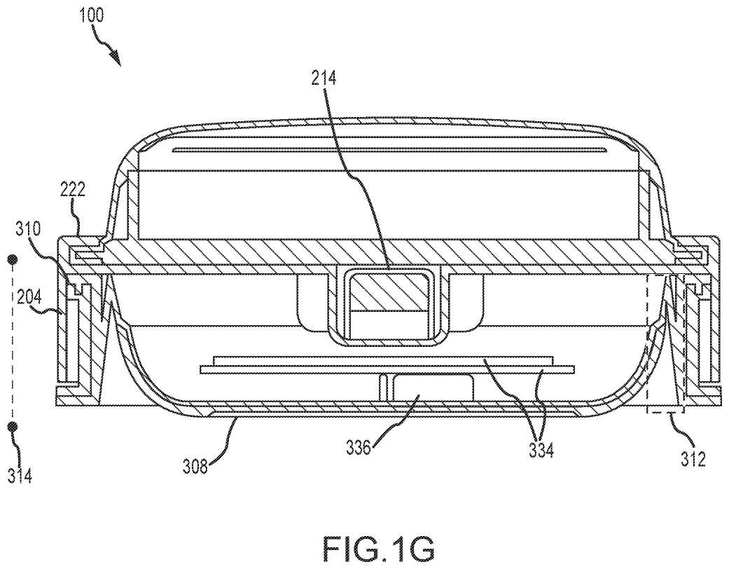

FIGS. 1A-5 and the following description depict specific examples to teach those skilled in the art how to make and use the best mode of the Application. For the purpose of teaching inventive principles, some conventional aspects have been simplified or omitted. Those skilled in the art will appreciate variations from these examples that fall within the scope of the Application. Those skilled in the art will appreciate that the features described below may be combined in various ways to form multiple variations of the Application. As a result, the Application is not limited to the specific examples described below, but only by the claims and their equivalents.

FIGS. 1A-1G depict a container 100 in accordance with an embodiment. FIG. 1A depicts a perspective view, FIG. 1B depicts an exploded view, FIG. 1C depicts an unfolded side view, FIG. 1D depicts a folded side view, FIG. 1E depicts an end view, FIG. 1F depicts a cross sectional view of unfolded container 100 as taken at A-A, as noted in FIG. 1C, and FIG. 1G depicts a cross sectional view of folded container 100 also taken at A-A.

Container 100 may be used to hold or store any item. In embodiments, container 100 may be used to store food. In embodiments, container 100 may be used to store food for a meal or food for multiple meals or snacks for an individual for a day.

Container 100 comprises a junction member 200 and a first compartment 300.

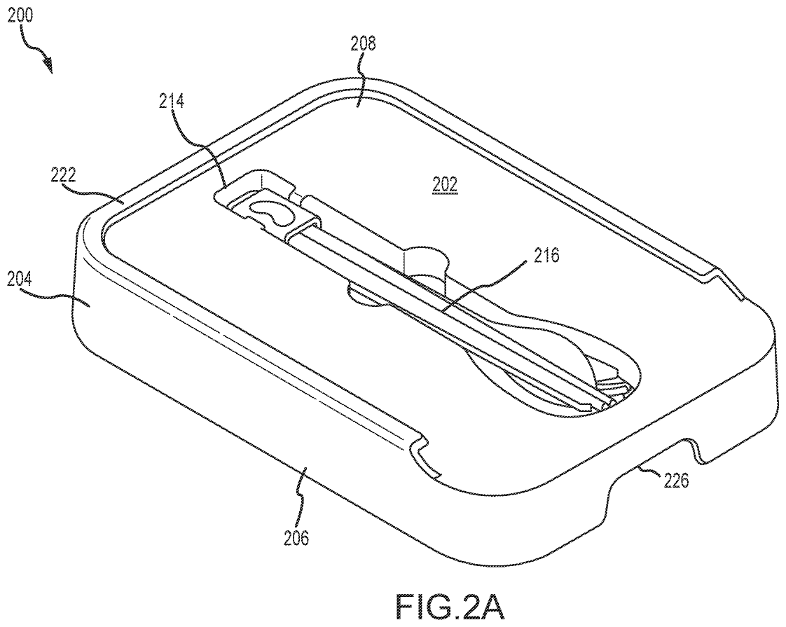

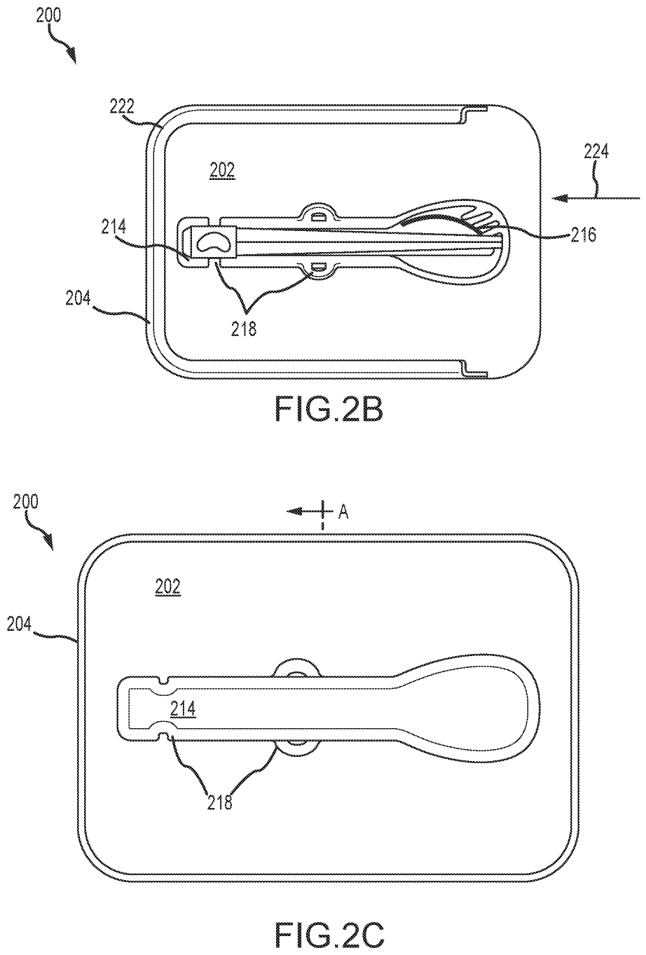

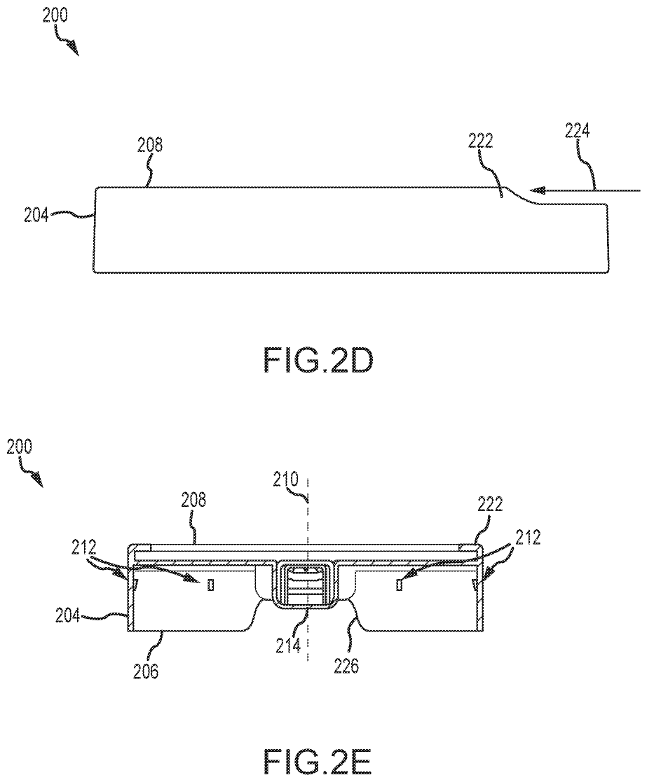

Junction member 200 may be used to seal first compartment 300. FIGS. 2A-2E depict junction member 200. FIG. 2A depicts a perspective view, FIG. 2B depicts a top view, FIG. 2C depicts a bottom view, FIG. 2D depicts a side view, and FIG. 2E depicts a cross-sectional view of junction member 200 as taken at A-A, as noted in FIG. 2C.

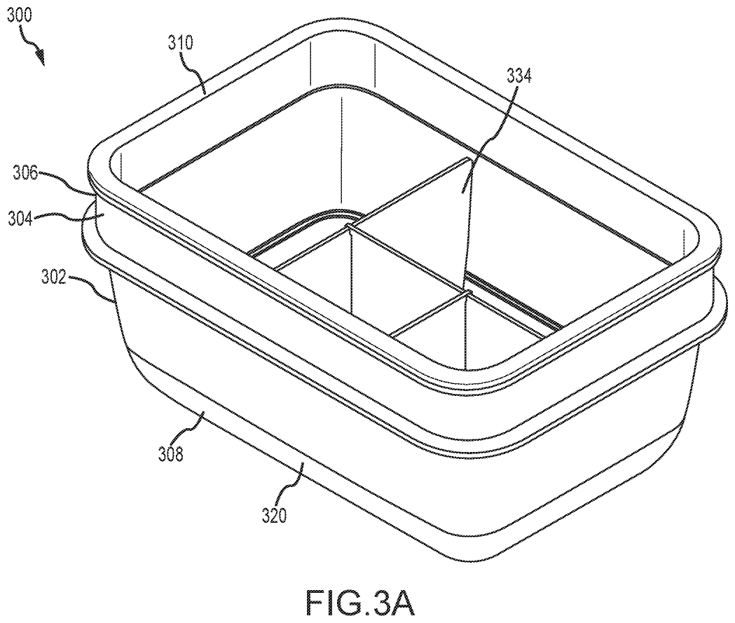

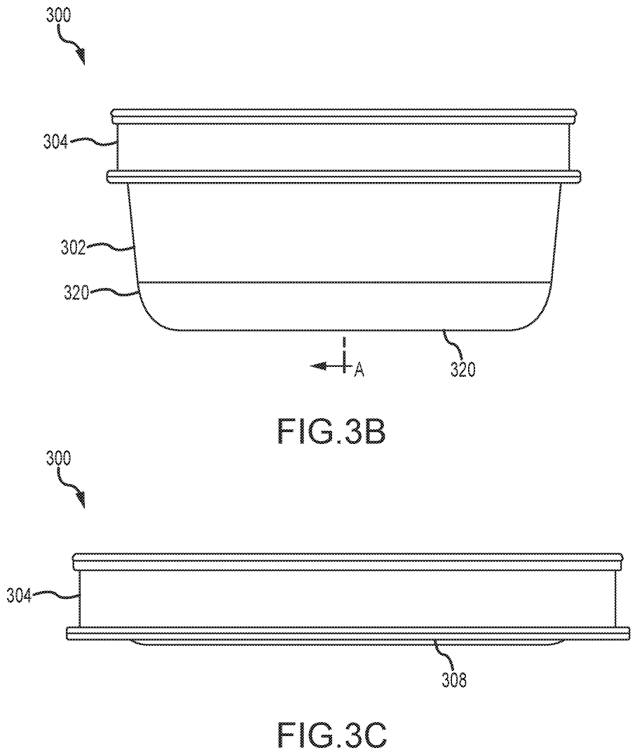

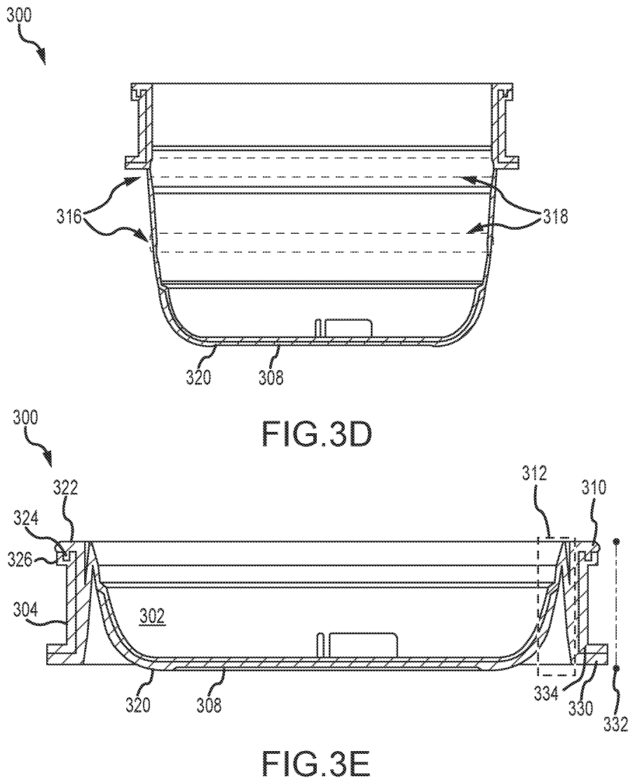

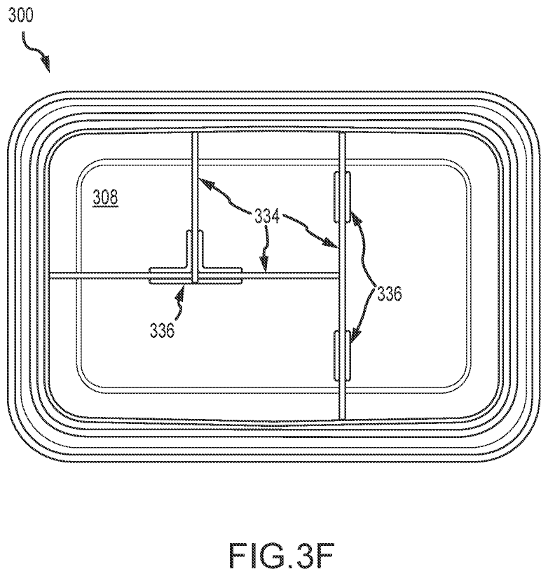

First compartment 300 may be used to store any item or material, such as food. FIGS. 3A-3F depict first compartment 300. FIG. 3A depicts a perspective view, FIG. 3B depicts an unfolded side view, FIG. 3C depicts a folded side view, FIG. 3D depicts a cross-sectional side view taken at A-A, as noted in FIG. 2B, FIG. 3E depicts a cross-sectional folded view A-A, as noted in FIG. 2B, and FIG. 3F depicts a top view of first compartment 300.

In embodiments, container 100 may further comprise a second compartment 400. Second compartment 400 may be used to store any item or material, much like first compartment 300. In embodiments, second compartment 400 may be used to store food.

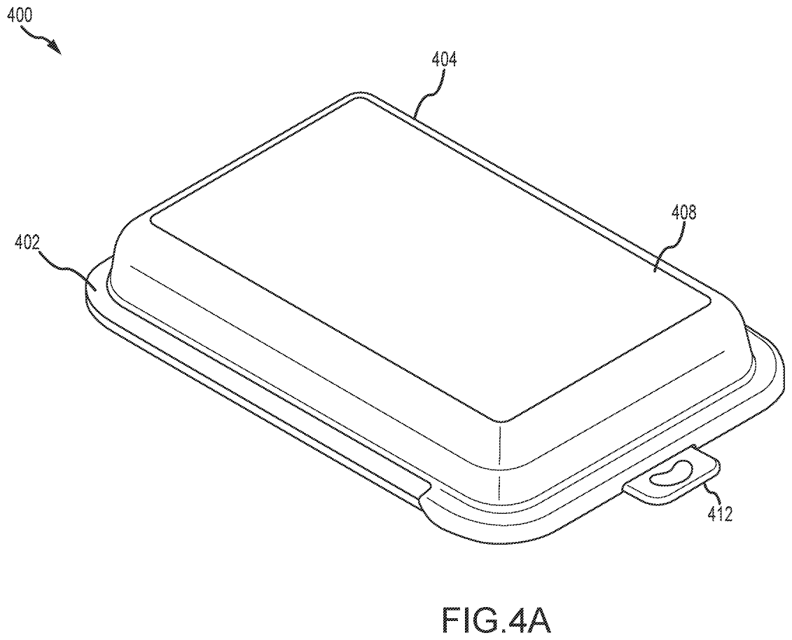

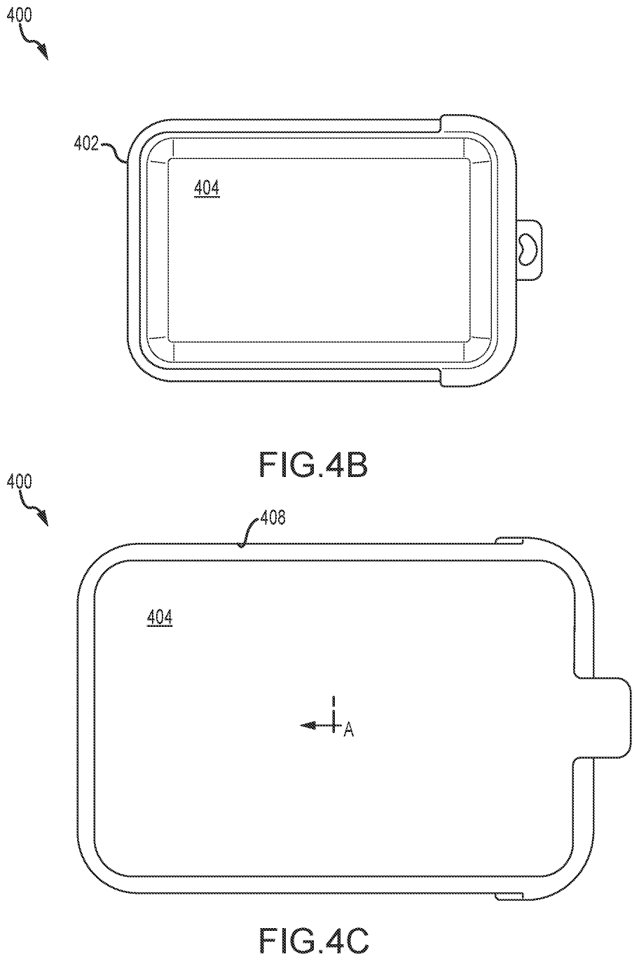

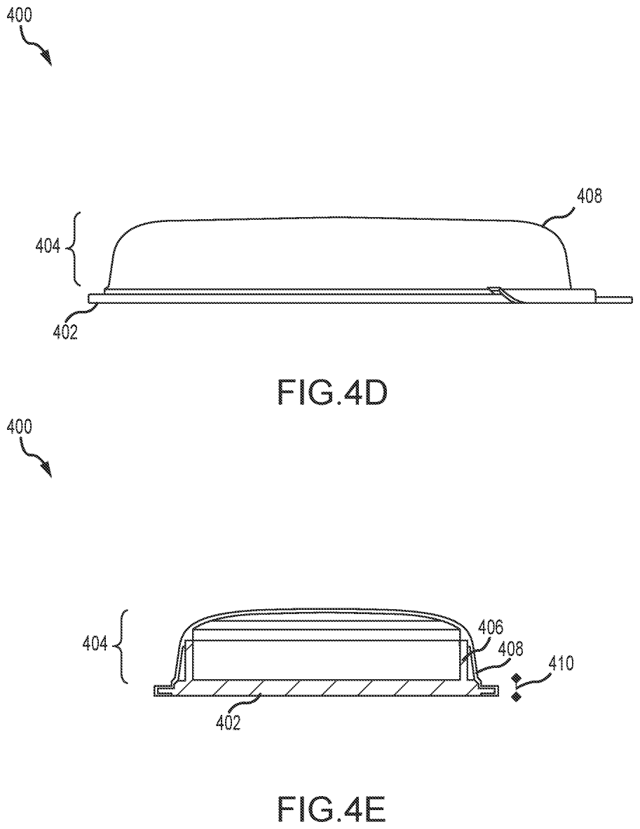

FIGS. 4A-4E depicts second compartment 400. FIG. 4A depicts a perspective view, FIG. 4B depicts a top view, FIG. 4C depicts a bottom view, FIG. 4D depicts a side view, and FIG. 4E depicts a cross-sectional of second compartment 400 as taken at A-A, as noted in FIG. 4D.

Junction member 200 comprises a junction member planar portion 202. Turning to FIGS. 2A-2C, it may be seen that junction planar member 202 is shaped substantially as a rectangle with rounded corners. This is not intended to be limiting, however. In further embodiments, junction planar member 202 may take any shape, as will be understood by those of skill.

Junction member planar portion 202 is surrounded around a periphery by a junction member band portion 204. Junction member band portion 204 takes the cross-sectional shape of the periphery of junction member planar portion 202, with an added height dimension in a direction parallel to the normal of the junction member planar portion 202. In the example embodiment of junction member 200, best seen in FIGS. 2A, 2D and 2E, it may be seen that junction member band portion 204 is not necessarily uniform in height along the periphery of junction member planar portion 202, which will be further described below.

Turning to FIG. 2E, it may be seen that junction member band portion 204 comprises a first end 206 and a second end 208 along a longitudinal axis 210 of the junction member band portion 204. Junction member band portion 204 further comprising one or more extensions 212 projecting inward from the junction member band portion between the junction member planar portion 202 and the first end. In embodiments, one or more extensions 212 may comprise any shape known to those of skill operable to retain a mouth lip from first compartment 300, as is further described below.

In embodiments, one or more extensions 212 may comprise tabs that are rectangular in shape. In embodiments, one or more extensions 212 may increase in height in a direction normal to the inner surface of the junction member band portion 204 on the side of one or more extensions 212 closest to second end 208 to provide a sort of press fit or generate a “pop” feedback sound when mouth lip 310 of first compartment 300 is seated between function member planar surface 202 and one or more extensions 212. In embodiments, one or more extensions 212 may comprise a continuous ring around the inside surface of junction member band portion 204, or many smaller discontinuous surfaces.

In embodiments, junction member band portion 204 may further comprise one or more indentions 226, as may best be seen in FIGS. 1E, 2A, and 2E. One or more indentions 226 may be positioned along a first end 206 of junction member band portion 204 and configured to allow a user to apply pressure to a portion of first container 300, thereby breaking the seal between junction member 200 and first container 300 to release first container 300, as further described below.

One or more indentions 226 may be positioned along any portion of junction member band portion 204.

Turning to FIG. 3A, first compartment 300 may be seen. First compartment 300 comprises a first compartment storage portion 302 made of silicone with a mouth end 306 and a bottom end 308. First compartment storage portion 302 is a container with a mouth operable to be closed via coupling to junction member 200. In the example embodiment of container 100, first compartment storage portion 302 is substantially rectangular with rounded edges in shape, with slight narrowing in the walls towards bottom end 308. In further embodiments, however, first compartment storage portion 302 may comprise any shape known to those of skill.

In embodiments, first compartment storage portion 302 may comprise platinum silicone to provide a container with improved food safety. In embodiments, any other silicone component of container 100 may also comprise platinum silicone. Platinum silicone may help facilitate food safety certification, and it may help provide container 100 with a superior finish.

First compartment 300 further comprises a first compartment band 304 positioned around the mouth end of the first compartment storage portion 302. First compartment band 304 is formed from a material that is stiffer than the material comprising first compartment storage portion 302, and functions to provide rigidity around the mouth of first compartment 300, thereby providing structure to container 100. In embodiments, first compartment band 304 may be formed from plastic, composite, or bamboo. In further embodiments, first compartment band 304 may be formed from any material capable of providing additional stiffness to the mouth of first compartment 300, while allowing just enough flex to facilitate moving a mouth lip 310 into position between one or more extensions 212 and junction planar member 202 or being released by a user applying pressure at one or more indentions 226, as will be known to those of skill.

In embodiments, first compartment band 304 may be positioned on an exterior surface of first compartment storage portion 302 to prevent first compartment band 304 from coming into contact with the contents stored within the first compartment 300. In embodiments, first compartment band 304 may be further coupled to first compartment storage portion 302 using an adhesive, such as a food-grade adhesive. In further embodiments, first compartment band 304 may be further coupled to first compartment storage portion 302 using any other method known to those of skill.

Mouth end 306 of first compartment 300 comprises mouth lip 310 configured to be sealingly retained between junction member planar portion 202 and one or more extensions 212 of junction member 200. Mouth lip 310 may comprise a substantially flat surface that optimal for sealing against junction member planar portion 202. In embodiments, mouth lip 310 may provide a more ridged structure than the body of first compartment storage portion 302 to improve the seal between junction member 200 and first compartment 300. In embodiments, mouth lip 310 may be configured so that the silicone of first compartment storage portion 302 wraps around the first compartment band 304 to provide a silicone surface on mouth lip 310 for improved sealing, as is further described below.

First compartment storage portion 302 is configured to be folded at one or more predetermined pleats 312 so that at least 85% of a height of the one or more predetermined pleats fits within a volume of the junction member band portion 204 when the first compartment is coupled to the junction member of the container. By pleat, what is meant is two adjacent sections of a folded material connected via one angled bend in the material. For example, turning to Figures IG or 3E, it may be seen that first compartment storage portion 302 is folded into 1.5 pleats 312 between mouth lip 310 and bottom end 308. At least 85% of the height 314 of one or more pleats 312 fits within the volume of junction member band portion 204. In embodiments, a small portion of bottom end 308 or base portion 320 may extend below junction member 200 or first compartment band member 304, as may be seen in FIGS. 1D and 3C. As may be seen in the example embodiment, a small portion of first compartment storage portion 302 adjacent to bottom end 308 protrudes below the lowest end of junction member band portion 204.

In further embodiments, one or more predetermined pleats 312 may be configured so that at least 90%, 95%, or 100% of the height 314 of one or more pleats 312 fit within a volume of junction member band portion 204 when first compartment 300 is coupled to junction member 200 of container 100.

Alternatively, in embodiments, one or more predetermined pleats 312 may be configured so that at least 85%, 90%, 95%, or 100% of the height 314 of one or more pleats 312 fit within a volume of first compartment band 304.

In embodiments, first container storage portion 300 further comprises an average thickness of silicon, with one or more sections of silicone 316 that are thinner than the average silicone thickness of first container storage portion 300, as may be seen in FIG. 3. The one or more sections of silicone 316 are configured to allow first container storage portion 302 to form one or more predetermined pleats 312 when pressure is applied to bottom end 308 of first container portion 300. In embodiments, one or more sections of silicone 316 may comprise ring-shaped regions 318 of thinner silicone arranged parallel to the periphery of first container storage portion 302, as is depicted in FIG. 3D, surrounded by dotted lines. In embodiments, the ring-shaped regions 318 may be continuous or discontinuous around a perimeter of first container storage portion 302.

In embodiments, first compartment storage portion 302 may comprise walls that have an average thickness that is between 1-4 mm. In further embodiments, however, first compartment storage portion 302 may have an average thickness that is between 2-3 mm. In embodiments, the one or more sections of silicone 316 that are thinner may be a fraction of a millimeter thinner than the average thickness. In embodiments, the one or more sections of silicone 316 may be 0.2-0.5 mm thinner, for example.

Those of skill will understand that, by using one or more sections of silicone 316 comprising ring-shaped regions 318 of thinner silicon, it is possible to avoid the stepped profiles of prior art silicone containers. Prior art silicone containers use silicone having stepped profiles to facilitate folding that reduce the width of the container steeply to facilitate orderly silicone folding. The rapid narrowing of prior containers makes for a less room for storage, and a less aesthetically pleasing container to eat out of. Moreover, to avoid having the silicone dangle very far below the hard plastic covers when folded, prior art containers use a larger number of folds. Those of skill will readily understand that using one or more sections of silicone 316 comprising ring-shaped regions 318 of thinner silicone allows container 100 to have fewer predetermined pleats 312, so that that the sides of the body of first container storage portion 302 will make the impression to the user as being predominantly vertical and smooth when unfolded.

In embodiments, the one or more sections of silicone 316 that are thinner than the average silicone thickness of first container storage portion 300 may be positioned on an interior surface of first container storage portion 302, as may best be seen in FIG. 1F. This may allow the outside of first container storage portion 300 to provide a flush, smooth appearance.

In embodiments, one or more sections of silicone 316 may comprise a triangular cross-section pointing towards the exterior surface of first container storage portion 302, to better facilitate folding. In further embodiments, however, one or more sections of silicone 316 may comprise any cross-sectional area known to those of skill.

In embodiments, first compartment storage compartment 302 may comprise walls that are positioned at an angle that is between 0 to 15 degrees of the normal from a surface of bottom end 308. In embodiments, first compartment storage portion 302 may comprise walls that are positioned at an angle that is between 5 and 10 degrees of the normal from a surface of bottom end 308. This may provide a larger volume eating container that is more aesthetically pleasing than the prior art silicone containers that narrow excessively due to the stepped side walls that facilitate folding.

Moreover, because the one or more predetermined pleats 312 can be designed to tuck away using the full height of first compartment band 302 or function member planar portion 202 when folded, it is possible to provide first container storage portion 302 with fewer pleats. For example, first container storage portion 302 may be provided with as few as 1.5 predetermined pleats 312. Having fewer predetermined pleats 312 may provide a container that, when folded, allows for further room inside the pleats for other features/components, as is further described below.

In embodiments, the steepness, average thickness, and one or more sections of silicone 316 that are thinner than the average silicone thickness of first container storage portion 300 may allow one or more predetermined pleats 312 to roll when folded. This may allow a substantial height of at least one pleat of one or more predetermined pleats 312 to remain substantially in contact when folded, providing more space within a folded first container storage portion 302, as may be best seen in FIG. 1F. In embodiments, first container storage portion 302 may further comprise a base portion 320 coupled to bottom end 308. Base portion 320 may be formed from a material that is stiffer than silicone and coupled bottom end 308. For example, as may be seen in FIGS. 3B. 3D, and 3E, base portion 320 may comprise a tray shape that substantially follows the shape of the bottom of first container storage portion 302. In the example embodiment, base portion 320 comprises a substantially rectangular tray with rounded corners. This is not intended to be limiting, however, as base portion 320, like first container storage portion 302, may take any format known to those of skill.

In embodiments, base portion 320 may comprise a base portion height that is at least 85%, 90%, 95%, or 100% the distance between bottom end 308 and an adjacent section of silicone 316 that is thinner to facilitate orderly folding into pleats 312. This may further help first container storage portion 302 fold in an orderly fashion.

In embodiments, base portion 320 may further comprise a central bump-up portion pushing up from bottom end 308 towards mouth end 306. This may help container 100 avoid suction when placed on a flat surface.

In embodiments, base portion 308 may be formed, then placed into the mold in which silicone first container storage portion 302 is formed. Heat and pressure may then be applied between base portion 308 and the silicone material of first container storage portion 302 to couple the two materials together. In further embodiments, base portion 308 and first container storage portion 302 may be coupled together via adhesive, or via any other method known to those of skill.

In embodiments, base portion 308 may be formed from nylon. In further embodiments, base portion 308 may be formed from any material that may provide stiffness to bottom end 308 that is suitable for coupling to the silicone of first container storage portion 302 known to those of skill. In embodiments, base portion 308 may be coupled to an exterior side of first container storage portion 302, as is depicted in FIG. 3E so that food only comes into contact with the silicone material of first container storage portion 302.

Base portion 308 may further provide rigidity and stiffness to silicone first compartment storage portion 302. Especially in the situation where first container 300 is relatively large, for example when it may be formed to store a liter or more of contents, base portion 308 may act as a guide that helps with the orderly folding of predetermined pleats 312 of first compartment storage portion 302. Base portion 308 may therefore allow for the walls of first compartment storage portion 302 to be much thinner than prior containers while folding in an orderly, repeatable manner. By allowing the average thickness of first compartment storage compartment 302 to be thinner, base portion 308 may further allow container 100 to comprise less silicone, making it less expensive to manufacture, more sustainable, and lighter weight in general. In embodiments, container 100 may weigh as little as 350 grams.

In embodiments, base portion 308 may further provide a more solid feel to container 100 when it is unfolded or stowed in a folded position.

In embodiments, base portion 308 may be coupled into the base portion 308 of first container portion 300 so as to provide a flush exterior of first container portion 300.

In embodiments, mouth lip 310 of first compartment storage portion 302 may further comprise an annular ring portion 322, as may be seen in FIG. 3E. Annular ring portion 322 may extend away from the center of the first compartment storage portion 302 at mouth end 306. In embodiments, annular ring portion 322 may comprise a flat surface facing junction member 200 to provide a seal against junction member planar portion 202. In further embodiments, however, annular ring portion 322 may have a raised ridge to provide a seal against junction member planar portion 202.

First compartment storage portion 302 may further comprise a perpendicular portion 324 that extends away from annular ring portion 322 in a direction towards bottom end 308 of first compartment storage portion 302. First compartment band 304 may further comprise a rail lip 326 at a first end of the first compartment band 304 configured to seat around perpendicular portion 324 of first compartment storage portion 302. Perpendicular portion 324 and rail lip 326 may help couple first compartment storage portion 302 and first compartment band 304 together in a way that provides a flat, substantially rigid seal at mouth lip 310, thereby providing superior silicone sealing for the contents of first compartment 300 when seated against junction member 200.

In embodiments, first compartment storage portion 302 may further comprise a lower seat lip 330 spaced apart from annular ring portion 322, wherein a distance between annular ring portion 322 and lower seat lip 330 may be configured to snuggly secure first compartment band portion 304 to first compartment storage portion 302 between annular ring portion 322 and lower seat lip 330. In embodiments, first compartment band 304 may further comprise a lower band lip 334 configured to seat against lower seat lip 330, thereby further preventing first compartment band 304 from moving up or down with respect to mouth lip 310. In embodiments, adhesive, for example a food grade adhesive, may be further used to couple first compartment band 304 securely to first compartment storage portion 302.

In embodiments, junction member planar portion 202 may further comprise a depression 214 configured to hold one or more tools 216, as may be seen in FIGS. 2A-2C and 2E. In embodiments, one or more tools 216 may comprise any combination of fork, spoon, spork, knife, and/or chopsticks. In embodiments, depression 214 may be configured to avoid obstructing or interfering with the folding of one or more predetermined pleats 312 positioned within junction member band portion 204 when first compartment 300 is coupled to junction member 200 and folded. For example, as may best be seen in Figure IF, depression 214 is centered within junction member planar portion 202 so that it does not interfere with one or more pleats 312. In embodiments, depression 214 may be configured into a shape of one or more tools 216. In embodiments, depression 214 may further comprise one or more tabs 218 to secure one or more tools 216 when stored therein, as may best be seen in FIGS. 2B and 2C. In embodiments, one or more tabs 218 may be designed to secure one or more tools 216 while also being easy for a user to release.

The example embodiment of FIGS. 2A-2E depicts one or more tools 216 comprising a combination spork and chopsticks seated in depression 214. In embodiments, as may be seen in FIG. 1B, one or more tools 216 may further comprise a tool hook 220 coupled to one of the one or more tools 216 and configured to secure the other of the one or more tools 216 together before storing them in depression 214.

In embodiments, one or more tools 216 may be formed from any appropriate material known to those of skill. For example, one or more tools 216 may be formed from BPA-free polypropylene.

In embodiments, first container storage portion 302 may further comprise one or more removable dividers 334 configured to be placed in the first container storage portion 302, thereby subdividing the first container storage portion 302. As may be best seen in FIGS. 1F and 3C, one or more removable dividers 334 may be substantially planar with edges that follow the contours of the sides of first compartment storage portion 302. Dividers 334 may be especially useful when container 100 is used to store food. In embodiments, one or more removable dividers 334 may be fabricated from silicone, or any other material known to those of skill.

In embodiments, one or more removable dividers 334 may be coupled into first container storage portion 302 by pressing them into one or more divider slots 336. In embodiments, divider slots 336 may comprise two extensions on inner surface of bottom end 308 of first container storage portion 302, configured to sandwich the substantially planar one or more removable dividers 334 therebetween. In embodiments, one or more divider slots 336 may comprise parallel extensions configured to hold a single divider or T-shaped extensions configured to hold two or three dividers.

As may be seen in Figure IF, one or more removable dividers 334 may be configured to fit between one or more predetermined pleats 312 of first container storage portion 302 when first container 300 is coupled to and folded into junction member 200. In embodiments, one or more removable dividers 334 may be configured to fit between any combination of depression 214 for one or more tools 216 and divider slots 336 as well. The feature that one or more removable dividers 334 may be stored in an assembled, folded container 100 may provide storage that is flexible and may be stowed compactly and conveniently with all parts when not in use.

In embodiments, container 100 may further comprise a second compartment 400. Second compartment 400 may be operable to store any item, for example any food item. As may be seen in FIGS. 4A-4E, second compartment may comprise a second compartment planar portion 402 and a second compartment storage portion 404 coupled to a surface of the second compartment planar portion. In embodiments, the second compartment storage portion 404 may take any shape or format known to those of skill operable to provide storage.

In embodiments of container 100 that include second compartment 400, second end 208 of junction member 200 may be configured to couple to the second compartment planar portion 402.

As may best be seen in FIGS. 2A, 2B, 2D and 2E, in embodiments, junction member 200 may further comprise a junction member rail 222 positioned at the second end of the junction member band portion 204. In embodiments, junction member rail 222 may comprise any structure operable to couple to second compartment planar portion 402. In embodiments, junction member rail 222 may surround at least a portion of a circumference of the junction member band portion 204 and be configured to seat second compartment planar portion 402 when second compartment 400 is inserted into junction member rail 222 via a sliding motion parallel to the length of the second compartment planar portion 224. FIG. 2E best depicts a cross-sectional area of example embodiment junction rail member 222. It may be seen that junction rail member 222 extends perpendicularly inward from junction member band portion 204. As may further be seen in FIGS. 2B and 2D that junction rail member 222 may substantially surround three sides of junction member 200, so that second compartment 400 may be slid into junction member 200 in the direction indicated by arrow 224 and retained therein.

Those of skill will understand that the example of coupling junction member 200 to second compartment 400 via junction rail member 222 is not intended to be limiting. In further embodiments, other methods of coupling junction member 200 to second compartment 400 are envisioned, as will be understood by one of skill in the art.

In embodiments, second compartment storage portion 404 may further comprise a second compartment container portion 406 and a second compartment cover 408. In embodiments, second compartment container portion 406 may comprise, for example, a tray-like container formed from a surface of second compartment planar surface 402 and any number of interconnecting walls normal to the surface of second compartment planar surface 402, as may be seen in the cross-sectional view of FIG. 4E. In embodiments, the walls of second compartment container portion 406 surrounding a surface of second compartment planar surface 402 may take any shape or form. In embodiments, second compartment container portion 406 and second compartment planar surface 402 may formed as an integrated piece.

In embodiments, second compartment cover 408 may be configured to seal the second compartment container portion 406. In embodiments, second compartment cover 408 may be configured to seat around a periphery of the second compartment planar portion 402. For example, as may be seen in FIG. 4E, second compartment cover 408 wraps around three edges of second compartment planar portion 402. This may be further seen in the bottom view of FIG. 4C, where second compartment cover 408 may be seen as wrapping around the back of the periphery of second compartment planar surface 402.

In embodiments, junction member rail 222 may be configured to seat a combined height 410 of second compartment planar portion 402 and second compartment cover 408. FIG. 4E best depicts height 410 of second compartment planar portion 402 and second compartment cover 408 combined, and Figure IG depicts second compartment planar portion 402 and second compartment cover 408 fitted inside junction member rail 222. The example embodiment is not intended to be limiting, however. In further embodiments, second compartment cover 408 may seal second compartment container portion 406 via any other method known to those of skill.

In embodiments, second compartment 400 may be fabricated from silicon. In further embodiments, second compartment cover 408 may be fabricated from silicone having a first weight and second compartment container portion 406 may be fabricated from a silicone having a second weight that is higher than the first weight, thereby providing a stiffer second compartment container portion 406 and a more flexible second compartment cover 408. In further embodiments, however, any material or combination of materials may be used to fabricate second compartment 200 known to those of skill.

In embodiments, second compartment 400 may further comprise a tab 412, which may be best seen in FIGS. 4A and 1A. Tab 412 may make it easier for a user to grip and slide second compartment 400 out of junction member rail 222.

By providing a second container portion, it is possible for container 100 to offer additional compartments for storage. When first and second compartments 300 and 400 are disassembled from junction member 200, first compartment 300 and second compartment 400 may offer different plate or tray-like surfaces which may be used to enjoy separate portions of a meal. Alternatively, first compartment 300 and second compartment 400 may be used to store different meals or meal/snack combinations altogether.

In embodiments, first compartment band 304 and/or the junction member 200 may be fabricated from plastic. For example, first compartment band 304 and/or the junction member 200 may be fabricated from a food-safe, BPA-free polypropylene. By minimizing the amount of plastic used in container 100, container 100 may provide rigidity in a container featuring predominately silicone components. The rigidity provided by the minimal plastic used in container 100 may further help to maintain excellent sealing between first compartment 300 and junction member 200, or second compartment 400 and junction member. Minimizing plastic in container 100 further minimizes potential contact between food and plastic, preventing the transfer of chemicals like phthalates that are often resident in plastics to food contained therein. In this way, container 100 may provide a safe, sustainable, reusable, practical, less expensive, and aesthetically pleasing lunch container that is ready for certification as food safe.

In embodiments, silicone surfaces of first compartment 200 and second compartment 400 may comprise a finish to prevent scratching in the soft silicone material.

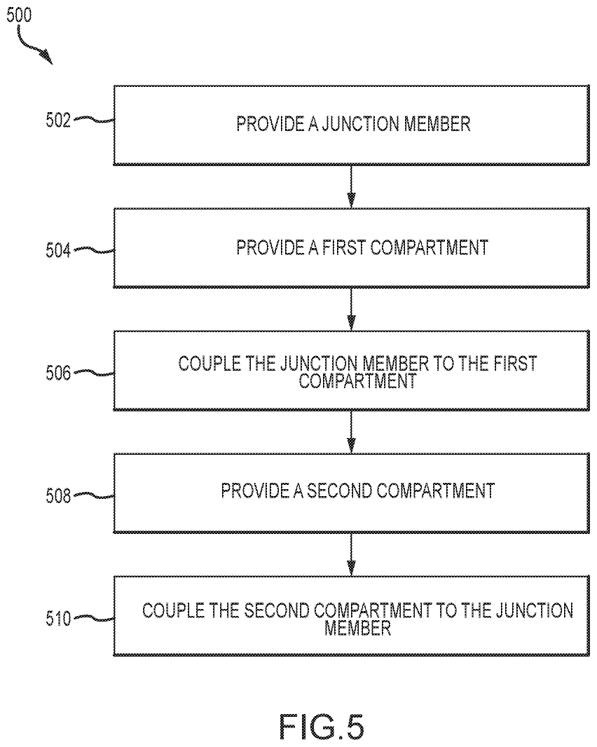

FIG. 5 depicts method 500, in accordance with an embodiment. Method 500 may be used to fabricate container 100. Method 500 comprises steps 502 to 506.

In step 502, a junction member 200 is provided, as described above.

In step 504, a first compartment 300 is provided, as described above.

In step 506, junction member 200 is coupled to first compartment 300, as described above.

In embodiments, method 500 may further comprise steps 508 and 510. In step 508, a second compartment 300 may be provided, as described above.

In step 510, second compartment 400 may be coupled to the junction member 200, as described above.

The detailed descriptions of the above examples are not exhaustive descriptions of all examples contemplated by the inventors to be within the scope of the Application. Indeed, persons skilled in the art will recognize that certain elements of the above-described examples may variously be combined or eliminated to create further examples, and such further examples fall within the scope and teachings of the Application. It will also be apparent to those of ordinary skill in the art that the above-described examples may be combined in whole or in part to create additional examples within the scope and teachings of the Application. Accordingly, the scope of the Application should be determined from the following claims.

What is claimed is:

1) A container (100) comprising:
a junction member (200) comprising a junction member planar portion (202) surrounded on a periphery by a junction member band portion (204), the junction member band portion (204) comprising a first end (206) and a second end (208) along a longitudinal axis of the junction member band portion (204), the junction member band portion (204) further comprising one or more extensions (212) projecting inward from the junction member band portion (204) between the junction member planar portion (202) and the first end (206);
a first compartment (300) comprising a first compartment storage portion (302) comprising silicone with a mouth end (306) and a bottom end (308), and a first compartment band (304) positioned around the mouth end (306) of the first compartment storage portion (302), wherein the mouth end (306) comprises a mouth lip (310) configured to be sealingly retained between the junction member planar portion (202) and the one or more extensions of the junction member (212), and the first compartment storage portion (302) being configured to be folded via one or more predetermined pleats (312) so that at least 85% of a height (332) of the one or more predetermined pleats (312) fits within a volume of the junction member band portion (204) when the first compartment (300) is coupled to the junction member (200).

2) A container (100) as claimed in claim 1, wherein the first container storage portion (302) further comprises an average thickness of silicon, with one or more sections (316) of silicone that are thinner than the average thickness and configured to allow the first container storage portion (302) to form the one or more predetermined pleats (312) when pressure is applied to the bottom end (308) opposing the mouth end (306) of the first container portion (302) in the direction of the mouth end (306).

3) A container (100) as claimed in claim 1, wherein the first container storage portion (302) further comprises a base portion (320) coupled to the bottom end (308), the base portion (320) being formed from a material that is stiffer than silicone and coupled to the bottom end (308).

4) A container (100) as claimed in claim 1, wherein the mouth lip (310) of the first compartment storage portion (302) further comprises an annular ring portion (322) that extends away from the center of the first compartment storage portion (302) at the mouth end (306) and a perpendicular portion (324) that extends away from the annular ring portion (322) towards the bottom end (308) of the first compartment storage portion (302), and the first compartment band (304) further comprises a rail lip (326) at a first end of the first compartment band (328) configured to seat the perpendicular portion (324) of the first compartment storage portion (302).

5) A container (100) as claimed in claim 1, wherein the first compartment storage portion (302) further comprises a lower seat lip (330) spaced apart from the rail lip (326), a distance between the rail lip and the lower seat lip (332) being configured to snuggly secure the first compartment band portion (304) to the first compartment storage portion (304) between the rail lip (326) and the lower seat lip (330).

6) A container (100) as claimed in claim 1, wherein the junction member planar portion (202) further comprises a depression (214) configured to hold one or more tools (216), wherein the depression (214) does not interfere with folding the one or more predetermined pleats (212) within the junction member band portion (204) when the first compartment (300) is coupled to and folded into the junction member (200).

7) A container (100) as claimed in claim 1, further comprising:
one or more removable dividers (334) configured to be placed in the first container storage portion (302), thereby subdividing the first container storage portion (302).

8) A container (100) as claimed in claim 7, wherein the one or more removable dividers (334) are configured to fit within the one or more predetermined pleats (312) of the first container storage portion (302) when the first container (300) is coupled to and folded into the junction member (200).

9) A container (100) as claimed in claim 1, further comprising:
a second compartment (400) comprising a second compartment planar portion (402) and a second compartment storage portion (404) coupled to a surface of the second compartment planar portion (404), wherein the second end (208) of the junction member (200) is configured to couple to the second compartment planar portion (402).

10) A container (100) as claimed in claim 9, wherein the junction member (200) further comprises a junction member rail (222) positioned at the second end (208) of the junction member band portion (204), the junction member rail (222) surrounding at least a portion of a circumference of the junction member band portion (204) and configured to seat the second compartment planar portion (402) when inserted into the junction member rail (222) via a sliding motion in a direction (224) parallel to the length of the second compartment planar portion.

11) A container (100) as claimed in claim 9, wherein the second compartment storage portion (404) further comprises a second compartment container portion (406) and a second compartment cover (408) configured to seal the second compartment container portion (404).

12) A container (100) as claimed in claim 11, wherein the second compartment cover (408) is configured to seat around a periphery of the second compartment planar portion (402) and the junction member rail (222) is configured to seat a combined height of the junction member planar portion and the second compartment cover.

13) A container (100) as claimed in claim 12, wherein the second compartment cover is fabricated from silicone having a first weight and the second compartment container portion is fabricated from a silicone having a second weight that is higher than the first weight.

14) A container (100) as claimed in claim 9, wherein the first compartment band (304) and the junction member (200) are fabricated from plastic.

15) A method to fabricate a container (100) according to claim 1, the method comprising:
providing the junction member (200) comprising the junction member planar portion (202) surrounded on the periphery by the junction member band portion (204), the junction member band portion (204) comprising the first end (206) and the second end (208) along the longitudinal axis of the junction member band portion (204), the junction member band portion (204) further comprising one or more extensions (212) projecting inward from the junction member band portion (204) between the junction member planar portion (202) and the first end (206);
providing the first compartment (300) comprising the first compartment storage portion (302) comprising silicone with the mouth end (306) and the bottom end (308), and the first compartment band (304) positioned around the mouth end (306) of the first compartment storage portion (302), wherein the mouth end (306) comprises the mouth lip (310) configured to be sealingly retained between the junction member planar portion (202) and the one or more extensions of the junction member (212), and the first compartment storage portion (302) being configured to be folded via the one or more predetermined pleats (312) so that at least 85% of the height (332) of the one or more predetermined pleats (312) fits within the volume of the junction member band portion (204) when the first compartment (300) is coupled to the junction member (200); and
coupling the junction member 200 and the first compartment 300 together.

16) A method as claimed in claim 15, further comprising:
providing a second compartment (400) comprising a second compartment planar portion (402) and a second compartment storage portion (404) coupled to a surface of the second compartment planar portion (404), wherein the second end (208) of the junction member (200) is configured to couple to the second compartment planar portion (402);
and coupling the second compartment (400) to the junction member (200).

17) A method as claimed in claim 16, wherein providing the junction member (200) further comprises providing a junction member rail (222) positioned at the second end (208) of the junction member band portion (204), the junction member rail (222) surrounding at least a portion of a circumference of the junction member band portion (204) and configured to seat the second compartment planar portion (402) when inserted into the junction member rail (222) via a sliding motion; and wherein coupling the second compartment (400) to the junction member (200) further comprises sliding the second compartment (400) in a direction (224) parallel to the length of the second compartment planar portion.

18) A method as claimed in claim 16, wherein providing the second compartment (400) further comprises providing the second compartment storage portion (404) with a second compartment container portion (406) and a second compartment cover (408) configured to seal the second compartment container portion (404).

19) A method as claimed in claim 18, wherein providing the second compartment (400) further comprises configuring the second compartment cover (408) to seat around a periphery of the second compartment planar portion (402), and providing the junction member (200) further comprises configuring the junction member rail (222) to seat a combined height of the junction member planar portion (202) and the second compartment cover.
